(19) United States
(12) Patent Application Publication
(10) Pub. No.: US 2016/0381461 A1
(43) Pub. Date: Dec. 29, 2016

(54) Acoustic Driver Tensioner

(71) Applicant: MrSpeakers LLC, San Diego, CA (US)

(72) Inventors: Daniel W. Clark, San Dieto, CA (US); Robert Jason Egger, San Diego, CA (US)

(73) Assignee: MrSpeakers LLC

(21) Appl. No.: 15/196,624

(22) Filed: Jun. 29, 2016

Related U.S. Application Data
(60) Provisional application No. 62/186,011, filed on Jun. 29, 2015.

(51) Int. Cl. H04R 7/24; H04R 7/22; H04R 1/28; H04R 7/20

(52) U.S. Cl. CPC H04R 7/24; H04R 7/20; H04R 7/22; H04R 1/2811; H04R 2307/207

(57) ABSTRACT

An acoustic driver may have one or more flexible membranes that are configured to a predetermined tension. A flexible driver membrane can be positioned to continuously span a rigid frame. The rigid frame may have at least one suspension feature continuously applying force on the flexible driver membrane. A suspension feature can be a cantilever or enclosed spring each defined by a channel.

### RELATED APPLICATION

The present application makes a claim of domestic priority to U.S. Provisional Patent Application No. 62/186,011 filed Jun. 29, 2015, the contents of which are hereby incorporated by reference.

### SUMMARY

An acoustic driver, such as a planar magnetic or electrostatic transducer in accordance with assorted embodiments, has a flexible driver membrane spanning a semi-rigid frame. A flexible driver membrane is positioned to continuously span a rigid frame. The rigid frame has at least one suspension feature continuously applying force on the flexible driver membrane.

### BRIEF DESCRIPTION OF THE DRAWINGS

FIGS. 1A and 1B respectively display line representations of example audio driver environments in accordance with assorted embodiments.

FIG. 2 is a side view line representation of a portion of an audio driver that may be utilized in the environments of FIGS. 1A and 1B.

FIGS. 3A and 3B show top view line representations of portions of an example audio driver panel constructed in accordance with various embodiments.

FIG. 4 depicts a top view line representation of an example tensioning frame that can be utilized with the audio driver panel of FIGS. 3A and 3B.

FIG. 5 illustrates an example tensioning frame configured in accordance with assorted embodiments.

FIG. 6 shows a top view line representation of an example tensioning frame constructed and operated in accordance with some embodiments.

FIG. 7 is a top view line representation of an example tensioning frame arranged in accordance with assorted embodiments.

FIG. 8 provides a flowchart of an example acoustic driver routine carried out in accordance with various embodiments.

### DETAILED DESCRIPTION

There is a continued consumer and industry demand for increasingly accurate speakers. While speakers with large size and power demands can be constructed to be accurate, small-scale acoustic drivers that are designed to be mobile, such as headphones and portable speakers, can be hampered by relatively small space and power resources. The advent of planar magnetic and electrostatic acoustic transducers can, theoretically, produce very detailed and accurate sound reproduction. However, construction of planar magnetic and electrostatic components can be precise and delicate so that small deviations from design specifications, such as through incorrectly tensioned drivers, can drastically degrade the sound reproduction performance of the speaker.

It is contemplated that the tensioned suspension of a flexible membrane is an aspect of planar magnetic and electrostatic acoustic drivers that can be difficult to precisely construct and maintain in response to routine use. Hence, assorted embodiments of the present disclosure are directed to structures and methods that consistently tension a flexible membrane. The ability to tune the strength, location, and behavior of a suspension allows the acoustic properties of the flexible membrane to be tuned to optimize performance for a diverse range of speaker environments.

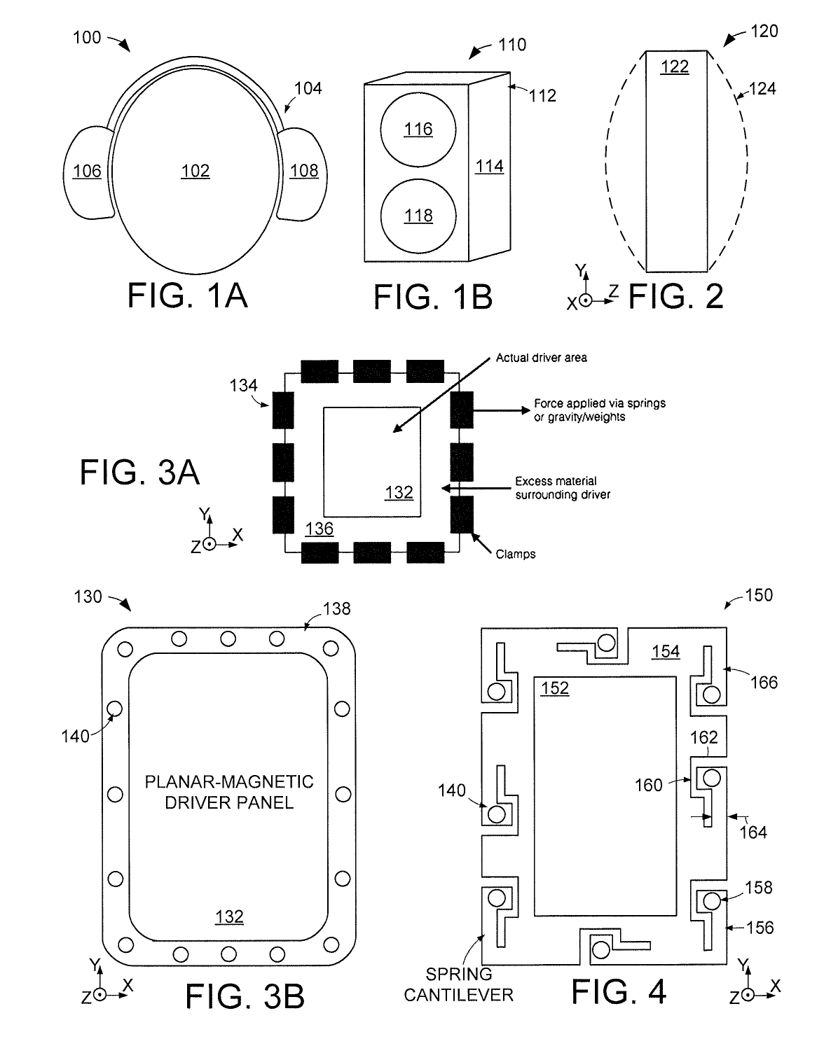

FIGS. 1A and 1B respectively display line representations of example acoustic driver systems 100 and 110 that are arranged and operated in accordance with various embodiments. In FIG. 1A, a user 102 is employing a pair of over-ear headphones 104 that has first 106 and second 108 acoustic drivers positioned proximal different ears of the user 100. It is noted that the over-ear configuration of the headphones 104 is not required as in-ear and on-ear arrangements may alternatively be used. Also, the number and style of acoustic drivers 106 and 108 are not limited and the headphones 104 may concurrently utilize numerous similar, or dissimilar, speakers.

The acoustic driver system 110 of FIG. 1B shows a stand-alone speaker 112 that is configured with a housing 114 that supports first 116 and second 118 acoustic drivers. The housing 114 can provide a volume of sealed or ported space behind the acoustic drivers 116 and 118 to allow for increased range and volume capabilities from the system 110 compared to the headphones 104 of FIG. 1A that have less available space.

FIG. 2 is a side view line representation of a portion of an example acoustic driver 120 that is constructed and operated in accordance with some embodiments. The acoustic driver 120 has a flexible membrane 122 that responds to electronic signals by moving to produce audible and non-audible sound. The sensitivity and accuracy of the flexible membrane's 122 response to the electronic signals corresponds with the quality of the acoustic driver 120. That is, the ability of the flexible membrane 122 to partially or completely vibrate and flex, as shown in exaggerated form by segmented lines 124, defines the driver's 120 performance and quality of sound reproduction. Incorrect tensioning of the driver 120 can degrade performance in multiple ways, such as, but not limited to, reduced bass output, non-linear high frequencies, inconsistent efficiency across units, crinkling noises, and other undesirable artifacts that can severely jeopardize a user's listening experience and complicate manufacturing of the driver 120.

FIGS. 3A and 3B respectively illustrate top view line representations of portion of an example speaker 130 that utilizes a flexible membrane 132 in accordance with assorted embodiments. FIG. 3A shows how the flexible membrane 132 can be tensioned with a number of securing means 134, such as clamps, clips, fasteners, and magnets. The tension in the flexible membrane 132 is tuned by attaching extra membrane material 136 at multiple fixed points. Weights and/or springs can be utilized to maintain the flexible membrane 132 in a selected tension while a rigid frame is secured in the extra material 136.

Installation of the rigid frame keeps the selected tension in the membrane 132 and the excess material 136 outside the frame is cut away and discarded. As a result, the membrane 132 is locked into the selected tension. However, incorrect tensioning or installation of the rigid frame can render the driver 130 useless as an accurate acoustic transducer and, as such, scrap.

FIG. 3B shows an alternative acoustic driver 130 that positions the flexible membrane 132 in a semi-rigid frame 138 that is constructed of some non-stretching, but flexible material. The flexible membrane 132 is affixed to the semi-rigid frame 138 with light or no tension and the frame 138 is subsequently secured to at least one fixed point that tensions the membrane 132 and frame 138 concurrently. While the semi-rigid frame 138 allows for future adjustment and tensioning in contrast to a rigid frame, the semi-rigid frame 138 does not automatically re-tension to adjust to changing driver 130 conditions. For instance, a semi-rigid frame 138 could be initially tuned to a desired tension that weakens in response to vibration and movement of the membrane 132. Although the semi-rigid frame 138 may be adjusted by hand after initial installation, such activity is time-consuming and causes the driver 130 to be at least partially disassembled by a professional.

Although not required or limiting, the flexible membrane 132 can have at least one conductive trace continuously extending in a pattern on the membrane 132. The number, location, size, and material of the conductive trace(s) can be tuned to provide planar magnetic operation when suspended proximal an array of magnets. In electrostatic operation, the flexible membrane is tuned for thickness and material to be conductive and respond to stator components that generate force to vibrate and move the membrane 132. Regardless of the flexible membrane's operation, the tension which the membrane 132 is suspended in the X-Y plane can drastically alter the sound, efficiency, and performance of the speaker.

When manufacturing the planar magnetic and electrostatic audio transducers, optimizing the tension of the flexible 132 ensures proper time domain and frequency domain performance. Historically, tension is applied through clamps and springs or pulleys and weights which are attached at multiple points around the driver membrane 132 and used to iteratively tension the panel until it is free of wrinkles and calibrated to the correct tension. For example, constructing the flexible membrane 132 can involve iteratively increasing or decreasing tension around the driver membrane 132. While highly effective, this is also a labor-intensive process.

Once the driver membrane 132 is tensioned, it is attached to a rigid frame using an adhesive to maintain panel tension in the intended application. The surrounding excess material 136 is trimmed away and the assembly is complete. At this point, the driver membrane 132 cannot be re-tensioned, and any error typically means the membrane and rigid frame combination is of no use and must be rebuilt.

Another method of fabricating planar drivers is where a flex-printed circuit board (PCB) 138 surrounds the driver membrane 132. This method does not typically ensure consistent driver tension, and the problem with consistency becomes more acute as the driver gets larger. In some cases, registration holes may be used to attach the flexible membrane 132 to a platform with a fixed spacing of attachment regions 140, such as pins, posts, or holes can be used to lightly tension the driver, or to simply hold it in place. However, this “one frame fits all” approach is plagued by requiring the driver membrane 132 be perfectly tensioned within the flexible frame, and no fine tuning of tension is possible, so variations in performance are inevitable.

In response to these challenges, various embodiments pre-tension the driver membrane 132 and semi-rigid frame 138 before attaching it to a rigid form by fitting the flex-PCB surrounded diaphragm over fixed posts via springs embedded in a rigid frame. While not required or limiting, assorted embodiments provide consistent spring force on the flexible membrane 132 within the rigid frame via one or more suspension features integrated into the frame, as illustrated in FIG. 4.

FIG. 4 conveys a top view line representation of a frame portion of an example acoustic driver 150 configured in accordance with various embodiments. The acoustic driver 150 has an internal membrane region 152 where a diaphragm can be positioned to span the rigid frame 154. The rigid frame 154 is configured to continuously exert spring force away from the membrane region 152, and a constituent driver membrane to provide uniform tension across the membrane region 152. The spring force is provided, in the non-liming embodiment of FIG. 4, with a plurality of suspension features 156 that are each configured as cantilevered protrusions that can be selectively affixed to one or more fixed points via a securing post 158.

Each suspension feature 156 is integrated into the frame 154 via a channel 160 defined by an aperture 160 that extends completely through the frame 154. The channel 160 is shaped to allow the suspension feature 156 to act as a spring and continuously apply force away to the membrane region 152 in the X-Y plane. The strength and behavior of the respective suspension features 156 can be adjusted by tuning the shape and size of the suspension feature 156. Each suspension feature 156 is embedded within or part of the rigid frame 154, and the channel 160 surrounding the spring suspension feature 156 is shaped to allow the spring a predetermined range of motion. By adjusting the thickness 164 and/or geometry of the cantilevered protrusion 166 produces more, or less, spring force on the membrane region 152.

In some embodiments, a flexible membrane 132 and semi-rigid frame 138 are assembled and attached to the rigid tension frame 154 within the membrane region 152. Such attachment can be facilitated by aligning one or more attachment regions 140 in frame 154 with posts 158 and the cantilevered protrusion 166, but the configuration is not required or limiting. Thus, the assorted suspension features 156, which are respectively connected by posts 158, exert force on a semi-rigid frame 138 that holds the flexible membrane 132 in the membrane region 152 from multiple points around the membrane 132. The utilization of the semi-rigid frame 138 spreads the force around the flexible membrane 132 between the connection posts 158, so as to ensure a smooth surface under even tension.

The different suspension features 156 can be tuned with different channel 160 shapes and different cantilever thicknesses 164 to precisely control the amount of tension placed on a membrane 132 positioned in the membrane region 152. The ability to tune the spring force from the respective suspension features 156 further allows a constituent membrane 132 to be customized for different sound applications, such as more low or high frequency response and also to account for variances in tension in the flexible membrane 132 and semi-rigid frame 138. While cantilevered protrusions can provide consistent spring force, various embodiments can employ other types of suspension features 156 to customize how the membrane 152 is tensioned.

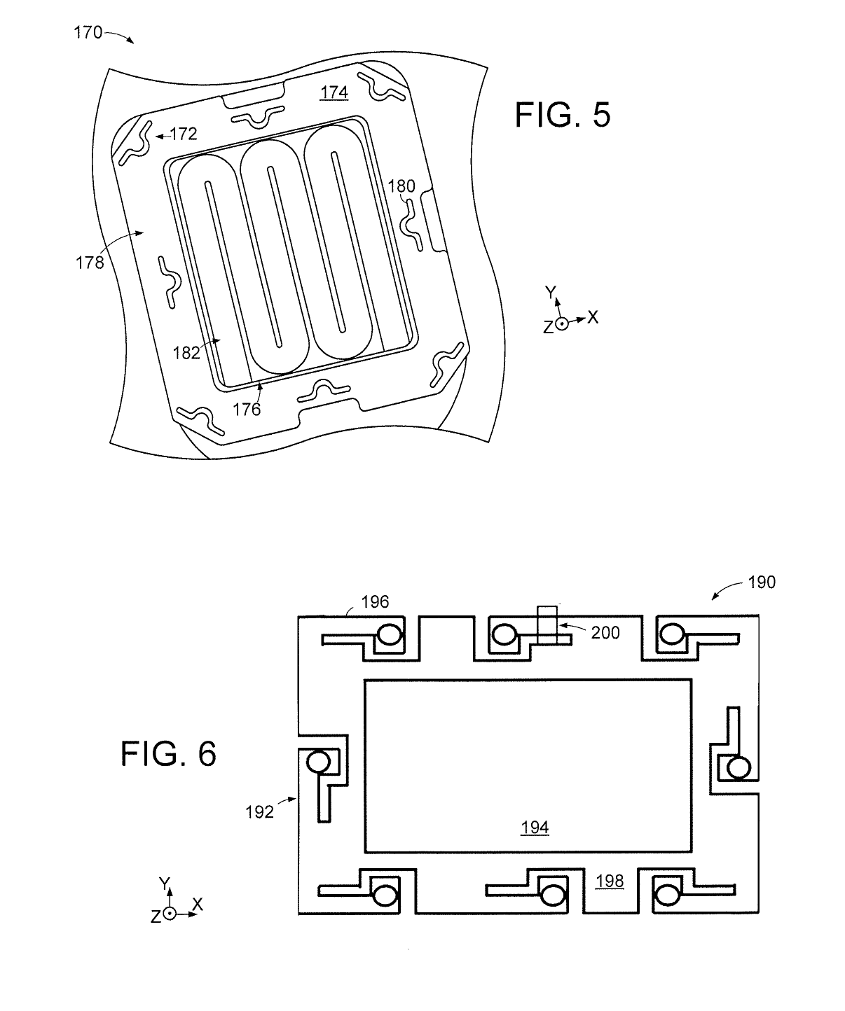

FIG. 5 illustrates a top view of a portion of an example acoustic driver 170 that has a plurality of suspension features 172 incorporated into a frame 174 on which a flexible driver assembly 176 is suspended. The driver assembly 176 can consist, in some embodiments, of a flexible membrane 132 spanning a semi-rigid frame 138. In comparison to the cantilevered suspension features of FIG. 4, the suspension features 172 of FIG. 5 are connected on both ends to fixed points and comprise a continuous channel 180 that is shaped to provide a continuous spring force on the flexible driver assembly 176. The tuned shape and size of the channel 180 allows the suspension feature 172 to flex so as to apply tension on the flexible membrane portion of the driver assembly 176 through posts that are not visible due to being on the opposite side of the frame 174.

By tuning the size, shape, and position of the assorted suspension features 172, a spring force can periodically or continually tension the membrane 176 to allow accurate response to electronic signals passing through the conductive trace 182. It is contemplated that a combination of cantilevered suspension features 156, which are attached via a single fixed point, are employed concurrently with one or more shaped channels that act as suspension springs, which are positioned between two fixed points, can provide continuous tension onto the membrane 176. Once the acoustic driver 170 has the correct tension, it is subsequently mounted to a baffle of a headphone or loudspeaker.

FIG. 6 shows a top view line representation of a portion of an example acoustic driver 190 that is configured in accordance with some embodiments to control the travel of the respective suspension features 192. It is contemplated that use of some membranes 194 may benefit from “fine tuning” of the force delivered through the cantilevered protrusions 196 of the frame 198. Accordingly, one or more tuning means 200, such as a set screw, strap, or magnet, can be positioned proximal the cantilevered protrusion 196 to apply more force to the cantilevered protrusion 196 than it inherently can produce to increase the force applied to the membrane 194.

Various embodiments utilize the tuning means 200 while constructing the acoustic driver 190 to reduce the amount of spring force tension applied to the membrane 194 without having to change the size, number, and shape of the suspension features 192, which can be time consuming due to a new frame 198 being constructed, such as 3D printed. Thus, a template frame 198 can be utilized with a predetermined number and configuration of suspension features 192, and/or suspension members 172, and the tuning means 200 can adjust the behavior of one or more suspension features 192 to control the application of spring force and tension on the membrane 194.

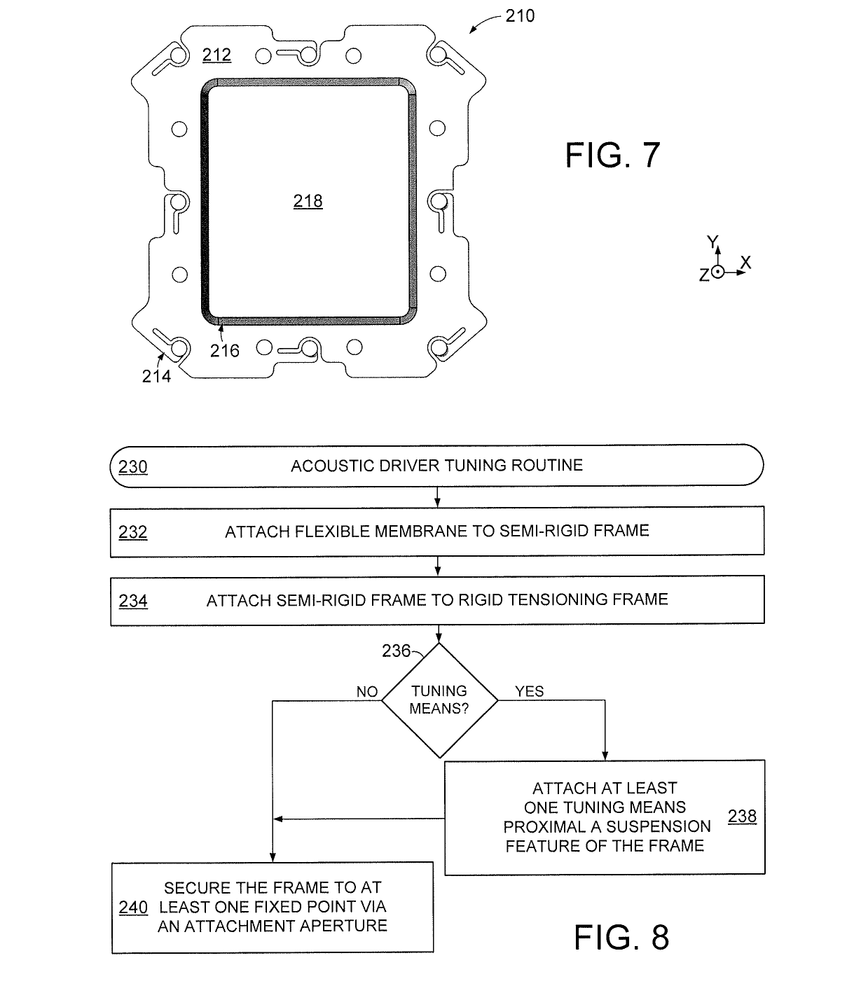

FIG. 7 illustrates a top view line representation of an example acoustic driver tensioning assembly 210 that employs continuously curvilinear channels 212 defining cantilevered suspension features 214. It is noted that rectangular channels, such as channel 160, can be used alone, or in combination with, curvilinear channels 212 to define cantilevered or enclosed suspension features that continuously apply spring force onto the semi-flexible membrane frame 216 and flexible membrane 218. The ability to tune the spring force applied to the membrane 218 by customizing the suspension type (cantilever or enclosed) and the suspension configuration (size and shape of the channel) allows for precise control of the structure and operation of the flexible membrane 218.

FIG. 8 is a flowchart of an example acoustic driver tuning routine 230 that may be performed in accordance with some embodiments. Initially, step 232 attaches a flexible membrane to a semi-rigid frame. Such attachment can be with adhesive, laminates, etched materials, etc. Next, the semi-rigid frame is attached within a membrane region of a rigid tensioning frame in step 234. The attachment in step 234 may be permanent or temporary and involves applying no tension to the membrane.

In various embodiments, the rigid tensioning frame has a plurality of suspension aspects that may be similar or dissimilar in type, size, and shape in the frame. It is contemplated that at least one suspension feature of the rigid tensioning frame can be altered. As a non-limiting example, a suspension channel can be altered to be made bigger, or a different shape, or altered by adding material, such as tape. The alteration of a suspension aspect can be done in regards to a static and or dynamic tension to be applied to the membrane. In addition, a multiplicity of tension frames may be fabricated to cover a range of panel tensions, which allows membrane panels to easily be fitted to the correct frame for a given application. That is, the alteration of step 234 can be conducted to tune how the suspension aspect behaves when the membrane is in motion, or not, and to compensate for variations in membrane tension to achieve target response curves.

Decision 236 then evaluates and determines if membrane tension is correct and if an adjustment is in order via the installation of one or more tuning means. If so, step 238 attaches one or more tuning means, such as a set screw to alter the suspension characteristics of a suspension feature, or member. It is contemplated that step 238 could replace the rigid tension frame with a different rigid frame having different spring properties. At the conclusion of step 238, or in the event decision 236 chooses not to utilize a tuning means, step 240 secures the frame to at least one fixed point via an attachment aperture in the frame.

In accordance with some embodiments, an acoustic driver system has at least a thin-membrane electrostatic, or planar magnetic driver, partially or completely surrounded by a flex-PCB frame that is incorporated in a rigid frame with an integrated spring-tensioning system. The acoustic driver system can be employed for a method of fine-tuning tension using custom springs or a series of frames with different geometry, tuning, or fabrication processes. In an exemplary approach, a flexible membrane is attached to a frame with spring force providing suspension features/members embedded directly in the frame. The springs may be single-ended cantilevers, or may be constructed more like a leaf-spring. Through the tuning of the suspension aspects of the frame, membrane tensioning is simplified with litter or no iteration and the membrane can be removed and installed on different frames with more appropriate spring strength

It should be noted while the embodiments have been directed to audio reproducing acoustic drivers, the claimed embodiments can readily be utilized in any number of other applications, including sonic wave producing systems. Furthermore, it is to be understood that even though numerous characteristics and configurations of various embodiments of the present disclosure have been set forth in the foregoing description, together with details of the structure and function of various embodiments, this detailed description is illustrative only, and changes may be made in detail, especially in matters of structure and arrangements of parts within the principles of the technology to the full extent indicated by the broad general meaning of the terms in which the appended claims are expressed.

What is claimed is:

1. An apparatus comprising a flexible driver membrane continuously spanning a rigid frame, the rigid frame having at least one suspension feature continuously applying force on the flexible driver membrane.

2. The apparatus of claim 1, wherein the frame is incorporated in a headphone.

3. The apparatus of claim 1, wherein the flexible driver membrane is suspended within a semi-rigid frame.

4. The apparatus of claim 3, wherein the semi-rigid frame is attached to the rigid frame via at least one attachment region.

5. The apparatus of claim 4, wherein the attachment region comprises a post of the semi-rigid frame extending through an aperture in the rigid frame.

6. The apparatus of claim 1, wherein the flexible driver membrane has at least one electrical trace.

7. The apparatus of claim 1, wherein the at least one suspension feature comprises a cantilevered spring.

8. The apparatus of claim 1, wherein the at least one suspension feature comprises an enclosed spring.

9. The apparatus of claim 1, wherein a first suspension feature of the at least one suspension feature is different than a second suspension feature of the at least one suspension feature.

10. An apparatus comprising:
a rigid frame; and
a flexible driver membrane attached to a semi-rigid frame, the semi-rigid frame attached to and continuously spanning the rigid frame, the rigid frame comprising a suspension feature continuously applying force on the flexible driver membrane, the suspension feature comprising a channel defining a cantilever.

11. The apparatus of claim 10, wherein the semi-rigid frame is attached to the rigid frame via attachment regions on the cantilever.

12. The apparatus of claim 11, wherein the semi-rigid frame is attached to the rigid frame only by the attachment regions located on a distal end of the cantilever.

13. The apparatus of claim 10, wherein the channel is defined by linear surfaces and has a rectangular shape.

14. The apparatus of claim 10, wherein the channel is defined by curvilinear surfaces and has a semi-circular shape.

15. The apparatus of claim 10, wherein the channel continuously extends entirely through the rigid frame.

16. An apparatus comprising a flexible driver membrane suspended within a semi-rigid frame and a rigid frame, the flexible driver membrane attached to the semi-rigid frame, the rigid frame comprising at least one suspension feature, the at least one suspension feature comprising a enclosed channel shaped to continuously apply a spring force on the flexible driver membrane.

17. The apparatus of claim 16, wherein the enclosed channel is shaped to define a cantilevered tab.

18. The apparatus of claim 17, wherein the cantilevered tab projecting towards the flexible driver membrane.

19. The apparatus of claim 16, wherein first, second, third, fourth, fifth, and sixth suspension features are spaced around the rigid frame and around the flexible driver membrane.

20. The apparatus of claim 19, wherein the first, second, third, fourth, fifth, and sixth suspension features are oriented at different angles with respect to the flexible driver membrane.
